(19) United States
(12) Patent Application Publication
(10) Pub. No.: US 2016/0146946 A1
(43) Pub. Date: May 26, 2016

(54) POSITION CALCULATION METHOD, POSITION CALCULATION DEVICE, AND POSITION CALCULATION PROGRAM

(71) Applicant: Seiko Epson Corporation, Tokyo (JP)

(72) Inventor: Naoki GOBARA, Shiojiri (JP)

(21) Appl. No.: 14/948,742

(22) Filed: Nov. 23, 2015

(30) Foreign Application Priority Data
Nov. 25, 2014 (JP) 2014-237408

(51) Int. Cl. G01S 19/23; G01C 22/00

(52) U.S. Cl. CPC G01S 19/23; G01C 22/006

(57) ABSTRACT

A position calculation method includes calculating a position of a movable body for a predetermined time period, determining whether or not there is a directional change of the movable body, and if it is determined that there is a directional change, recalculating a position of the movable body for each short period in a period which begins earlier than the time at which the determining is performed, wherein the short period is shorter than the predetermined time period.

This application claims priority to Japanese Patent Application No. 2014-237408, filed Nov. 25, 2014, the entirety of which is hereby incorporated by reference.

### BACKGROUND

1. Technical Field

The present disclosure relates to a position calculation method, a position calculation device, and a position calculation program.

2. Related Art

A technology has been known in which a module such as a position sensor is mounted on a user, and a movement distance or a movement trajectory of the user is measured (refer to JP-A-2013-42360 or the like). As the position sensor, for example, a global positioning system (GPS) receiver is used.

However, in the technology of the related art, when the movement direction of the user is considerably changed in a short period of time, the movement distance or the movement trajectory may not be able to be accurately assumed.

In the technology disclosed in JP-A-2013-42360, the number of times of position detection is controlled according to a state change of the user, but a timing at which the number of times of the position detection is changed is later than a timing at which the state change occurs, and thus it is difficult to suppress the inaccuracy during the state change.

### SUMMARY

An advantage of some aspects of the disclosure is to provide a position calculation method, a position calculation device, and a position calculation program which are suitable for increasing the assumption accuracy of a movement distance or the like.

The disclosure can be implemented as the following forms or application examples.

### Application Example 1

A position calculation method according to this application example includes calculating a position of a movable body at a predetermined cycle, determining the presence or absence of a directional change of the movable body, and recalculating the position of the movable body in a period which begins earlier than a timing at which the determining is performed for each short period which is shorter than the predetermined cycle when it is determined that there is a directional change.

In this manner, by recalculating the position in the period which begins earlier than the timing at which it is determined that there is a directional change, even when the determination timing is in a closing stage of the directional change or after the directional change, it is possible to calculate the position during the directional change. At this time, the position is calculated for each of the short periods which is shorter than the predetermined cycle, and thus it is possible to obtain a specific position compared to a case where the position is calculated at a predetermined cycle. Accordingly, even when the movement direction of the user is changed for a short period of time, it is possible to increase the assumption accuracy of a movement distance or the like in a period including a period of directional change.

### Application Example 2

In the position calculation method according to the application example, when an amount of directional change per unit time of the movable body is greater than a predetermined value, it may be determined that there is a directional change. According to this configuration, the recalculating is able to be performed when, for example, a steep curve, a steep slope, or the like occurs in the path of the movable body.

### Application Example 3

The position calculation method according to the application example may further include acquiring and accumulating data used for calculating the position at a cycle which is less than or equal to a length of the short period.

According to this configuration, it is possible to ensure the data which is able to be used for the recalculating.

### Application Example 4

In the position calculation method according to the application example, when it is determined that there is no directional change, the position may be calculated by using the data corresponding to the predetermined cycle.

According to this configuration, it is possible to calculate the position in the predetermined cycle.

### Application Example 5

In the position calculation method according to the application example, when it is determined that there is a directional change, the position may be recalculated using the data in the short period.

According to this configuration, it is possible to calculate the position in the short period using the data corresponding to the short period.

### Application Example 6

In the position calculation method according to the application example, the determining may be performed at a cycle identical to the predetermined cycle. According to this configuration, for example, it is possible to use a calculation result for the determination.

### Application Example 7

The position calculation method according to the application example may further include determining whether or not the movable body stops, and extending a length of the predetermined cycle when it is determined that the movable body stops.

According to this configuration, it is possible to suppress an amount of calculation in a period during which the movable body stops.

### Application Example 8

In the position calculation method according to the application example, signals from a plurality of positioning satellites may be used for calculating the position.

According to this configuration, it is possible to calculate an absolute position of the movable body.

### Application Example 9

A position calculation device according to this application example includes a position calculator calculating a position of a movable body at a predetermined cycle, and a determinator determining the presence or absence of a directional change of the movable body, in which the position calculator recalculates the position of the movable body in a period which begins earlier than a timing at which the determination is performed for each short period which is shorter than the predetermined cycle when it is determined that there is a directional change.

In this manner, by recalculating the position in the period which begins earlier than the timing at which it is determined that there is a directional change, even when the determination timing is in a closing stage of the directional change or after the directional change, it is possible to calculate the position during the directional change. At this time, the position is calculated for each of the short periods which is shorter than the predetermined cycle, and thus it is possible to obtain a specific position compared to a case where the position is calculated at a predetermined cycle. Accordingly, even when the movement direction of the user is changed for a short period of time, it is possible to increase the assumption accuracy of a movement distance or the like in a period including a period of directional change.

### Application Example 10

A position calculation program according to this application example causes a computer to execute calculating a position of a movable body at a predetermined cycle, determining the presence or absence of a directional change of the movable body, and recalculating the position of the movable body in a period which begins earlier than a timing at which the determining is performed for each short period which is shorter than the predetermined cycle when it is determined that there is a directional change.

In this manner, by recalculating the position in the period begins earlier than the timing at which it is determined that there is a directional change, even when the determination timing is in a closing stage of the directional change or after the directional change, it is possible to calculate the position during the directional change. At this time, a position is calculated for each of the short periods which is shorter than the predetermined cycle, and thus it is possible to obtain a specific position compared to a case where the position is calculated at a predetermined cycle. Accordingly, even when the movement direction of the user is changed for a short period of time, it is possible to increase the assumption accuracy of a movement distance or the like in a period including a period of directional change.

### BRIEF DESCRIPTION OF THE DRAWINGS

The disclosure will be described with reference to the accompanying drawings, wherein like numbers reference like elements.

FIG. 1 is a diagram for illustrating an outline of a position calculation device of an embodiment.

FIG. 2 is a functional block diagram illustrating a configuration example of the position calculation device.

FIGS. 3A and 3B are a flowchart of a GPS unit and a flowchart of a processor according to position calculation.

FIGS. 4A and 4B are diagrams illustrating position calculation of a standard mode and position calculation of a detail mode.

FIGS. 5A and 5B are diagrams illustrating a comparative example.

FIGS. 6A and 6B are diagrams illustrating an effect of the embodiment.

FIG. 7 is a diagram illustrating a modification example of the flowchart of the processor.

### DESCRIPTION OF EXEMPLARY EMBODIMENTS

Hereinafter, a preferred embodiment of the disclosure will be described in detail with reference to the drawings. Furthermore, the embodiment described below does not unduly limit the contents of the disclosure described in the appended Claims. In addition, it is not limited to that all configurations described in this embodiment are essential configuration requirements of the disclosure.

### 1. Position Calculation Device

### 1-1. Outline of Position Calculation Device

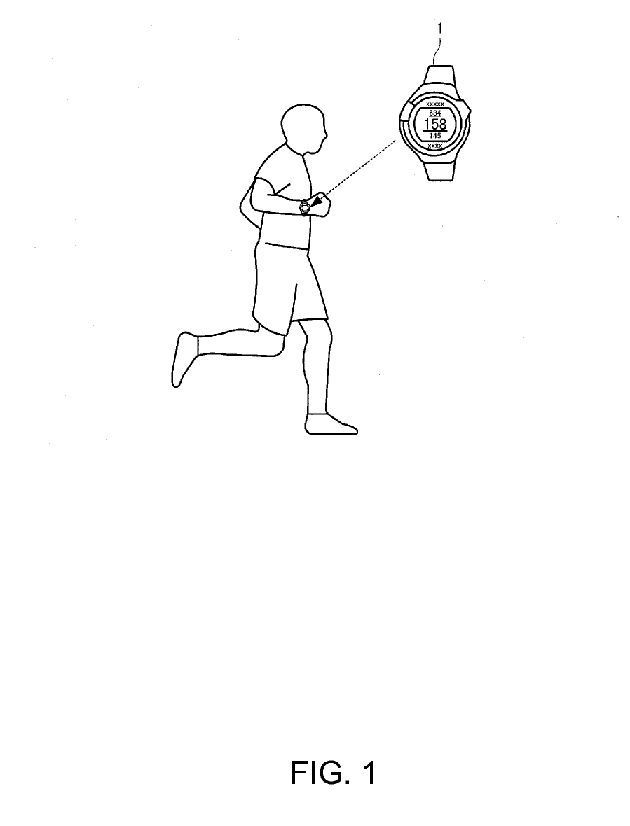

FIG. 1 is a diagram for illustrating an outline of a position calculation device of this embodiment. As illustrated in FIG. 1, in this embodiment, a person (a user) running is assumed as a movable body, and a wrist type (a wristwatch type) portable information device is assumed as a position calculation device 1. In this case, the position calculation device 1 is mounted on the wrist or the like of the user.

The user of this embodiment is able to operate the position calculation device 1 and to input a start command or the like to the position calculation device 1. For example, the position calculation device 1 of this embodiment starts measurement of the position of the user according to the start command, and notifies the user of the total movement distance from the start (an accumulative movement distance) in various forms such as a character, a diagram, or a sound in real time.

### 1-2. Configuration of Position Calculation Device

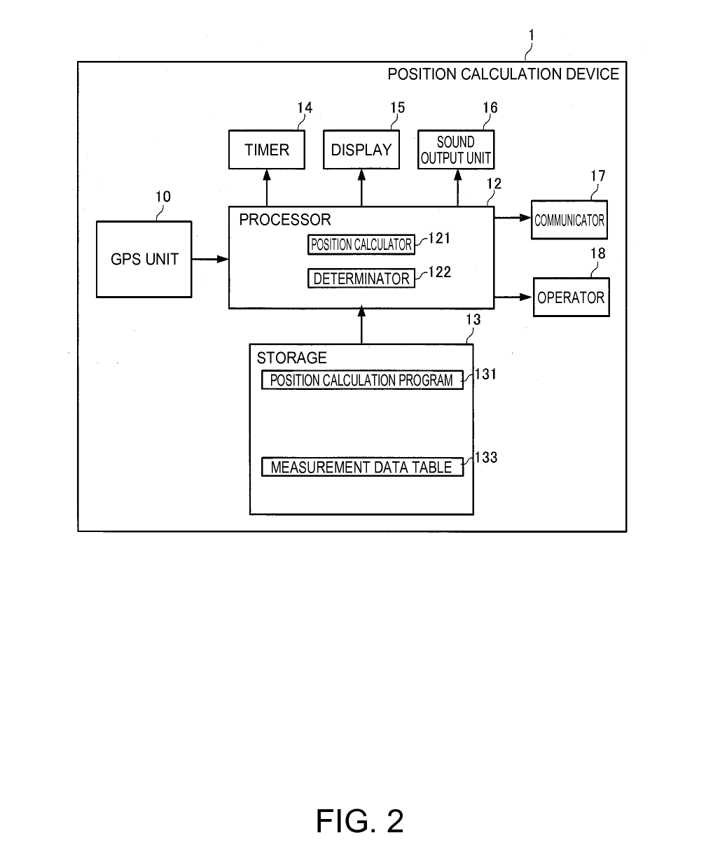

FIG. 2 is a functional block diagram illustrating a configuration example of the position calculation device 1. As illustrated in FIG. 2, the position calculation device 1 includes a GPS unit 10, a processor 12, a storage 13, a timer 14, a display 15, a sound output unit 16 (an audio 16), a communicator 17, an operator 18, and the like. Here, an example in which the position calculation device 1 uses a GPS which is one of satellite measurement systems will be exemplified.

The GPS unit 10 has a function of a GPS receiver. For example, the GPS unit 10 receives electromagnetic waves coming from the outside by an antenna (not illustrated), acquires one or a plurality of GPS satellites by searching a GPS signal which is encoded by a predetermined law (a frequency search, and a phase search) from signals included in the electromagnetic waves, and generates satellite orbit information, measurement data, and the like with respect to the GPS satellite by decoding the GPS signal. In the measurement data, a code phase of the received GPS signal, a received frequency of the GPS signal, and the like are included. In the code phase, a specific distance from the GPS unit 10 to the GPS satellite is reflected, and in the received frequency, a relative rate or the like between the GPS unit 10 and the GPS satellite is reflected. Furthermore, when there are a plurality of acquired GPS satellites, in the measurement data, information of the code phase and the received frequency is included for each of the GPS satellites.

The processor 12, for example, is configured of a central processing unit (CPU), a digital signal processor (DSP), an application specific integrated circuit (ASIC), and the like. The processor 12 is operated according to various programs such as a position calculation program 131 (described below) stored in the storage 13, and various commands input by the user through the operator 18, functions as a position calculator 121 as necessary, and functions as a determinator 122 as necessary.

The storage 13, for example, is configured of a read only memory (ROM), various IC memories such as a flash ROM, a random access memory (RAM), a hard disk, a recording medium such as a memory card, and the like. In the ROM, for example, a program such as the position calculation program 131 or data is stored, and in the RAM, for example, a storage region (a measurement data table 133 and the like) which is able to be used as a working area of the processor 12 is allocated.

The display 15 displays image data, text data, or the like transmitted from the processor 12 as a character, a graph, a table, an animation, and other images. The display 15, for example, is realized by a display such as a liquid crystal display (LCD), an organic electroluminescence (EL) display, and an electrophoretic display (EPD).

The timer 14 performs processing of generating time information such as year, month, day, hour, minute, and second. The timer 14, for example, is realized by a real time clock (RTC) IC or the like.

The sound output unit 16 outputs sound data transmitted from the processor 12 as a sound such as a voice or a buzzer sound. The sound output unit 16, for example, is realized by a speaker, a buzzer, or the like.

The communicator 17 communicates with an external device (not illustrated) (for example, a smart phone, a tablet PC, a laptop PC, a desktop PC, and the like, PC: Personal Computer), and transmits various information items generated by the processor 12 (for example, information such as positioning data, an accumulative movement distance, and a movement trajectory) to the external device. Furthermore, the communication between the communicator 17 and the external device may be performed through a network such as the Internet, and the external device may be a terminal of a network server or the like.

The operator 18 converts the contents of the command input from the user into a suitable signal and transmits the signal to the processor 12. The operator 18, for example, is realized by a button, a key, a microphone, and the like. Furthermore, when the display 15 is configured of a touch panel type display, at least a part of the function of the operator 18 is included in the display 15 side.

### 1-3. Basic Operation of Processor 12

Several basic operations of the processor 12 will be described.

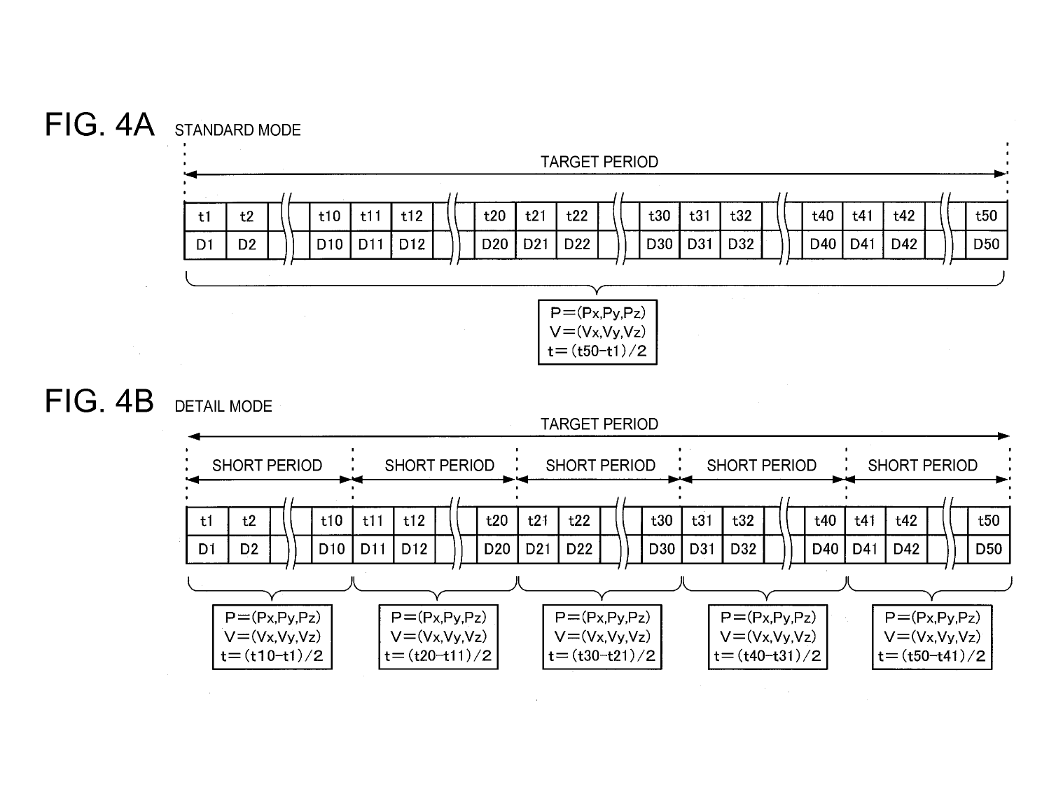

First, the processor 12 receives the measurement data which is repeatedly generated by the GPS unit 10 in the generation order, and writes the measurement data in the measurement data table 133 of the storage 13 in the reception order. Accordingly, in the measurement data table 133, the measurement data is accumulated in the chronological order. Furthermore, a horizontally long block in FIG. 4A described below is conceptual diagram of fifty measurement data items D1 to D50 which are temporally continued. A suffix i indicates the generation sequence, and i-th measurement data Di indicates measurement data generated at i-th time ti.

In addition, the processor 12 refers to continuous measurement data items (for example, the fifty measurement data items) generated in a predetermined period (for example, in one [sec] period) from the measurement data accumulated in the measurement data table 133, and executes known positioning calculation by using the continuous measurement data items, and thus generates a positioning result (positioning data) at the intermediate time of the period.

Here, in the positioning calculation, averaging processing such as integration is performed with respect to the continuous measurement data items (for example, the fifty measurement data items), and thus one positioning data item is generated from the averaged measurement data items. However, each of the measurement data items includes components such as the code phase, and the received frequencies which are different from each other for each GPS satellite, and thus the averaging processing is performed for each component and for each GPS satellite.

In addition, in the positioning data which is the positioning result, information such as position coordinates P, a velocity vector V, and a time t is included. Hereinafter, the position coordinates P, the velocity vector V, and the time t are respectively referred to as “positioning data P”, “positioning data V”, and “positioning data t”. The positioning data P is a vector quantity having components of three directions which are orthogonal to each other, and for example, is obtained on the basis of the code phases or the like of four or more GPS satellites. The positioning data V is a vector quantity having components of three directions which are orthogonal to each other, and for example, is obtained on the basis of the received frequencies of the like of four or more GPS satellites (a Doppler frequency or the like obtained from the received frequency).

In addition, the processor 12, for example, sequentially integrates a difference (a distance) between new positioning data P and the previous value of the positioning data P after starting the positioning, and thus an accumulative movement distance L of the user is calculated in real time.

Furthermore, the processor 12, for example, uses the satellite orbit information in addition to the measurement data at the time of starting the positioning. In addition, when a certain period has elapsed after the start of the positioning, the processor 12 is able to improve the accuracy of the positioning data P by using processing based on the history of the positioning data P (filter processing of a Karman filter or the like, assumption processing of a learning function, and the like). In addition, processor 12 evaluates the positioning data P at the time of calculating the accumulative movement distance L, and excludes the positioning data P which does not satisfy certain conditions from an integration target, and thus is able to improve the accuracy of the accumulative movement distance L.

However, here, for the sake of simplicity, the processing based on the history of the positioning data P and the evaluation of the positioning data P are omitted, and the length of a broken line which is able to connect points indicated by the positioning data P in the order of time is set to the accumulative movement distance L.

In addition, the processor 12 generates data for notification for notifying the user of the accumulative movement distance or the like, such as image data, text data, and sound data, and transmits the data to the display 15 and the sound output unit 16. The image data or the text data is converted into an image indicating the accumulative movement distance or the like in the display 15, and the sound data is converted into a sound indicating the accumulative movement distance or the like in the sound output unit 16.

### 1-4. Processing Procedure

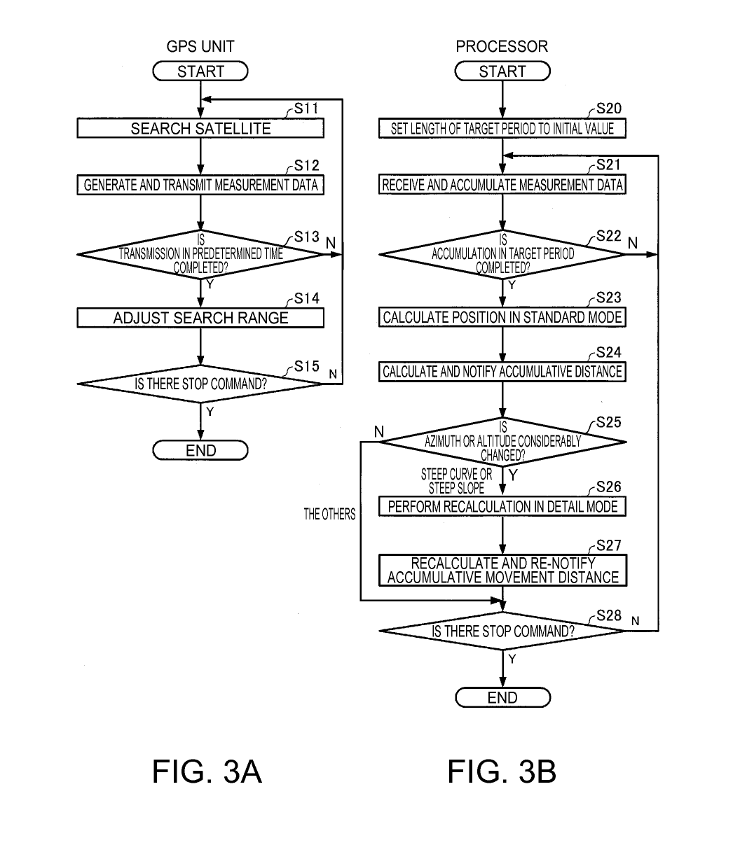

FIGS. 3A and 3B are flowcharts illustrating the procedure of the GPS unit 10 and the procedure of the processor 12 according to the position calculation.

A flowchart illustrated in FIG. 3A is a flowchart of the GPS unit 10, and a flowchart illustrated in FIG. 3B is a flowchart of the processor 12.

Both of the flowchart of the GPS unit 10 (FIG. 3A) and the flowchart of the processor 12 (FIG. 3B) start according to the start command from the user and end according to a stop command from the user.

Furthermore, the flowchart of the processor 12 (FIG. 3B) visualizes a main procedure of the position calculation program 131, the operations of Steps S23 and S26 mainly correspond to the operation of the position calculator 121, and the operation of Step S25 mainly corresponds to the operation of the determinator 122.

### 1-4-1. Flow of GPS Unit

Hereinafter, the flowchart of the GPS unit 10 (FIG. 3A) will be described for each step.

Step S11: The GPS unit 10 searches the GPS satellite (a frequency search, a phase search, and the like), and acquires the GPS satellite. Here, for the sake of simplicity, it is assumed that four or more GPS satellites are acquired.

Step S12: The GPS unit 10 generates the measurement data relevant to the acquired GPS satellite (the code phase, the received frequency, or the like for each GPS satellite), and transmits the data to the processor 12. Here, it is assumed that the measurement data is repeatedly generated at a cycle of 20 [msec].

Step S13: The GPS unit 10 determines whether or not a predetermined time T (here, it is assumed that T is 1 [sec]) has elapsed, and when the predetermined time T has elapsed, the flow returns to Step S11, and when the predetermined time T has not elapsed, the flow proceeds to Step S14. Accordingly, Steps S11 and S12 are repeated until the number of generation times of the measurement data reaches 50. Furthermore, the predetermined time T (here, 1 [sec]) is equal to the integer multiple of a sampling cycle of the measurement data (here, 20 [msec]).

Step S14: The GPS unit 10 improves the probability of capturing the GPS satellite in Step S11, and thus suitably adjusts a frequency search range, a phase search range, and the like, and then the flow proceeds to Step S15.

Step S15: The GPS unit 10 determines whether or not the stop command is received, when the stop command is not received, the flow returns to Step S11, and when the stop command is received, the flow ends.

### 1-4-2. Flow of Processor

Hereinafter, the flowchart of the processor 12 (FIG. 3B) will be described for each step.

Step S20: The processor 12 sets the length of a target period of the positioning calculation (corresponds to a predetermined cycle, and hereinafter, simply referred to as a “target period”) to an initial value. The length of the target period is basically set to be equal to the integer multiple of the sampling cycle of the measurement data (here, 20 [msec]). Here, it is assumed that the initial value of the target period is identical to T (here, 1 [sec]) described above.

Step S21: The processor 12 receives the measurement data transmitted from the GPS unit 10, and writes the received measurement data in the measurement data table 133 in the reception order. Furthermore, a time from generating one measurement data item to accumulating the one measurement data item is sufficiently shorter than the sampling cycle of the measurement data (20 [msec]), and the measurement data is accumulated (stored) in the measurement data table 133 in real time.

Step S22: The processor 12 determines whether or not the accumulation of all the measurement data items (here, fifty measurement data items) which are generated in the target period (here, 1 [sec]) is completed, and when the accumulation is not completed, the flow returns to Step S21, and when the accumulation is completed, the flow proceeds to Step S23. Furthermore, the horizontally long block illustrated in FIG. 4A is a conceptual diagram of the fifty measurement data items D1 to D50 which are generated in the target period (here, 1 [sec]). The suffix i indicates the generation sequence, and the i-th measurement data Di indicates the measurement data generated at the i-th time ti in the target period (here, 1 [sec]).

Step S23: The processor 12 performs the positioning calculation of a standard mode with respect to the measurement data (here, fifty measurement data items D1 to D50) which are generated in the target period (here, 1 [sec]), and thus acquires one of temporary positioning data items Pₜₑₘₚ, Vₜₑₘₚ, and tₜₑₘₚ.

Here, the positioning calculation of the standard mode is illustrated in FIG. 4A, and is performed by setting a range of averaging to be the entire target period. Accordingly, according to the positioning calculation of the standard mode, one of the temporary positioning data items Pₜₑₘₚ, Vₜₑₘₚ, and tₜₑₘₚ is calculated for the entire target period.

The temporary positioning data items Pₜₑₘₚ, Vₜₑₘₚ, and tₜₑₘₚ indicate the position and the velocity of the user at a time tₜₑₘₚ=(t50−t1)/2. The time tₜₑₘₚ=(t50−t1)/2 is the intermediate time of the target period.

Step S24: The processor 12, for example, calculates a temporary accumulative movement distance Lₜₑₘₚ at the present time on the basis of the temporary positioning data Pₜₑₘₚ acquired in Step S23, the most recently defined positioning data P, and the most recently defined accumulative movement distance L, and notifies the user of the temporary accumulative movement distance Lₜₑₘₚ in a predetermined form. Furthermore, the calculation principle of the temporary accumulative movement distance Lₜₑₘₚ is as described above, and the length of the broken line which is able to connect the points indicated by the positioning data P in the order of time is set to the accumulative movement distance.

Step S25: The processor 12, for example, an azimuth change amount (an amount of directional change) and an altitude change amount per unit time of the user at the present time are calculated on the basis of the temporary positioning data items Vₜₑₘₚ and tₜₑₘₚ acquired in Step S23, and the most recently defined positioning data items V and t. The azimuth change amount is an index indicating the steepness of a curve generated in the path of the user, and the altitude change amount is an index indicating the steepness of a slope generated in the path of the user. Then, the processor 12 determines whether or not the size of at least one of the azimuth change amount and the altitude change amount is greater than a threshold value (a predetermined value), when the size is greater than the threshold value, it is considered a steep curve or a steep slope is generated in the path of the user, and thus the flow proceeds to Step S26, and when the size is not greater than the threshold value, it is considered a steep curve or a steep slope is not generated in the path of the user, and the temporary positioning data items Pₜₑₘₚ, Vₜₑₘₚ, and tₜₑₘₚ are set to defined positioning data items P, V, and t, and then the flow proceeds to Step S28. That is, the processor 12 determines the presence or absence of a directional change in the movement of the user (the position calculation device 1 mounted on the user).

Furthermore, the processor 12 in Step S25 uses the same threshold value in the evaluation of the azimuth change amount and in the evaluation of the altitude change amount, and may use a separate threshold value. When a separate threshold value is used, the degree of the steep curve and the degree of the steep slope are able to be separately set.

Step S26: The processor 12 executes the positioning calculation again with respect to the measurement data (here, fifty measurement data items D1 to D50) generated in the target period which is identical to the target period of Step S23. However, the positioning calculation of this step is performed not in the standard mode but in a detail mode.

Here, the positioning calculation of the detail mode is illustrated in FIG. 4B, and is performed by setting the range of the averaging not to be the entire target period but to be each short period which is shorter than the target period. The length of the short period is equal to the integer multiple of the sampling cycle of the measurement data (here, 20 [msec]), and is one time the integer of the length of the target period (here, 1 [sec]). Here, it is assumed that the length of the short period is 200 [msec].

Accordingly, when the length of the target period is set to the initial value (here, 1 [sec]), five positioning data items P, V, and t are calculated from the target period according to the positioning calculation of the detail mode.

The positioning data items P, V, and t of the first short period indicates the position and the velocity of the user at a time t=t1+(t10−t1)/2. The time t=t1+(t10−t1)/2 is the intermediate time of the first short period.

In addition, the positioning data items P, V, and t of the second short period indicates the position and the velocity of the user at a time t=t11+(t20−t11)/2. The time t=t11+(t20−t11)/2 is the intermediate time of the second short period.

In addition, the positioning data items P, V, and t of the third short period indicates the position and the velocity of the user at a time t=t21+(t30−t21)/2. The time t=t21+(t30−t21)/2 is the intermediate time of the third short period.

In addition, the positioning data items P, V, and t of the fourth short period indicates the position and the velocity of the user at a time t=t31+(t40−t31)/2. The time t=t31+(t40−t31)/2 is the intermediate time of the fourth short period.

In addition, the positioning data items P, V, and t of the fifth short period indicates the position and the velocity of the user at a time t=t41+(t50−t41)/2. The time t=t41+(t50−t41)/2 is the intermediate time of the fifth short period.

Step S27: When the processor 12 calculates the defined accumulative movement distance L on the basis of the five positioning data items P acquired in Step S26, the previous value of the positioning data P, and the previous value of the accumulative movement distance L, the defined accumulative movement distance L is notified to the user in a predetermined form instead of the temporary accumulative movement distance Lₜₑₘₚ. Furthermore, when the accumulative movement distance L is notified to the user, the processor 12 may notify the user of the effect that the accumulative movement distance is defined.

Furthermore, the calculation principle of the defined accumulative movement distance L (Step S27) is identical to the calculation principle of the temporary accumulative movement distance Lₜₑₘₚ (Step S24), and the length of the broken line which is able to connect the points indicated by the positioning data P in the order of time is set to the accumulative movement distance.

Step S28: The processor 12 determines whether or not the stop command is received, when the stop command is not received, the flow returns to Step S21, and the processing relevant to the next target period starts. In contrast, when the stop command is received, the flow ends.

### 1-5. Effect of Embodiment

As described above, in this embodiment, the positioning calculation is executed in the standard mode insofar as the steep curve or the steep slope is not generated in the path of the user. The sampling cycle of the positioning data in the standard mode is T (here, 1 [sec]), and is sufficiently longer than the sampling cycle of the measurement data (here, 20 [msec]), and thus according to the standard mode, an effect of low power consumption is expected.

However, in the positioning calculation of the standard mode, the steep curve or the steep slope may not be able to be handled. Therefore, in this embodiment, as necessary, the positioning calculation of the detail mode is used.

Here, in order to describe the effect of this embodiment, a comparative example will be described. In the comparative example, the positioning calculation of the detail mode in this embodiment is omitted (Steps S25 to S27 described above are omitted).

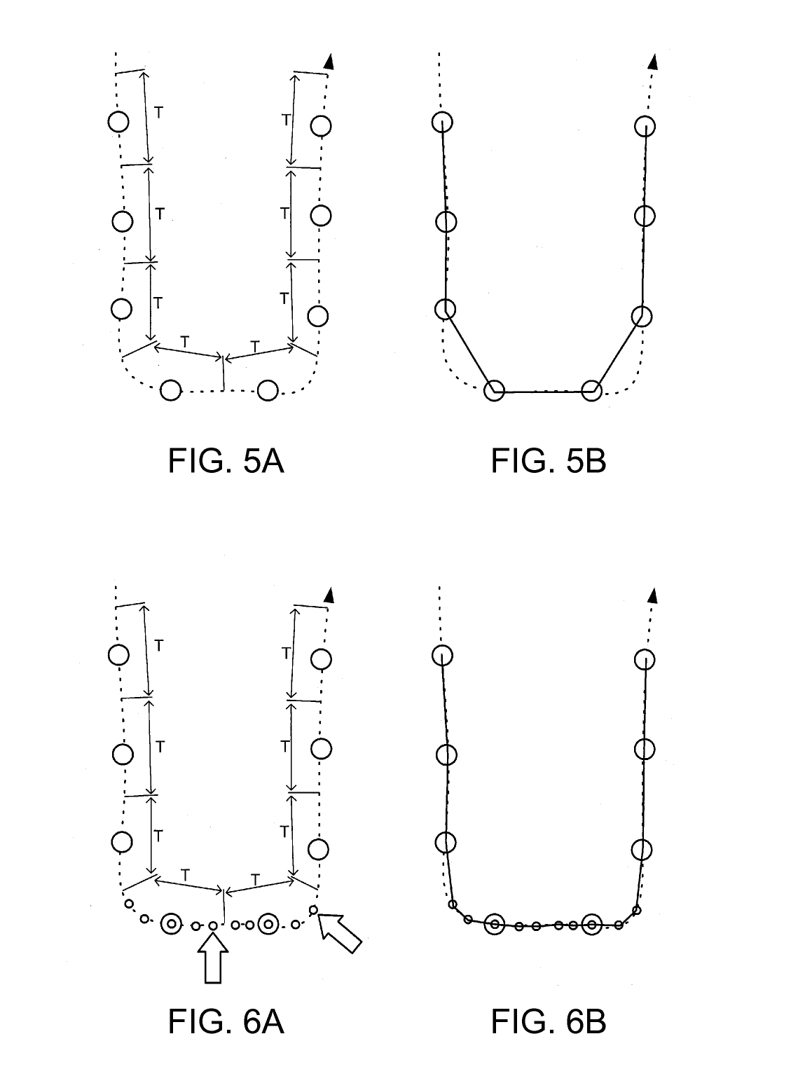

FIGS. 5A and 5B are diagrams illustrating the comparative example. In FIG. 5A, an actual movement trajectory is indicated by a dotted line, and a sampling point of the positioning data (that is, actually measured position coordinates) is indicated by a dot. In addition, in FIG. 5B, an actual movement trajectory is indicated by a dotted line, and a movement trajectory to be actually measured is indicated by a broken line. Furthermore, an accumulative movement distance which is actually measured in the comparative example is indicated by the length of the broken line illustrated in FIG. 5B.

In the comparative example, as illustrated in FIG. 5A, the positioning calculation of the detail mode is not executed, and thus a time difference in continuous sampling points (hereinafter, referred to as a “sampling interval”) is identical to a sampling cycle T of the standard mode.

For this reason, in the comparative example, when a precipitous curve (a steep curve) is generated in the path (a movement trajectory) of the user compared to the sampling cycle T of the standard mode, a sampling point for expressing a steep curved portion of the movement trajectory (lower right and lower left in FIG. 5A) is insufficient.

For this reason, in the comparative example, as illustrated in FIG. 5B, the movement trajectory which is actually measured is deviated from the actual movement trajectory, and as a result thereof, the accumulative movement distance which is actually measured may be deviated from an actual accumulative movement distance. Furthermore, the same applies to a case where not only the steep curve but also the steep slope is generated in the path of the user, but is not illustrated in FIGS. 5A and 5B.

FIGS. 6A and 6B are diagrams illustrating the effect of this embodiment. The explanatory note of FIGS. 6A and 6B is identical to the explanatory note of FIGS. 5A and 5B. In addition, a hollow arrow in FIG. 6A indicates an approximate timing at which the steep curve is determined, and in FIGS. 6A and 6B, a big dot indicates a sampling point of the standard mode, and a small dot indicates a sampling point of the detail mode.

In this embodiment, as illustrated in FIG. 6A, initial positioning calculation is performed in the standard mode, and thus an initial sampling interval is identical to the sampling cycle T of the standard mode. However, in this embodiment, when it is determined that the steep curve is generated in the path of the user, the positioning calculation relevant to the target period which is identical to that of the most recent standard mode is executed again in the detail mode. The sampling interval of the detail mode is shorter than the sampling cycle T of the standard mode.

Accordingly, in this embodiment, positioning calculation having a narrow sampling interval is performed again by going back to the past by a target period T at the timing at which the steep curve is generated. That is, the position of the user is recalculated by using a period including a period or a time which begins earlier than the timing at which the determination is performed as a target.

Accordingly, in this embodiment, even when the steep curve is generated in the path of the user, the sampling point for expressing the steep curve portion (lower right and lower left in FIG. 6A) is able to be replenished after the steep curve is generated (the small dot in FIG. 6A).

Accordingly, in this embodiment, as illustrated in FIG. 6B, the movement trajectory which is actually measured is close to the actual movement trajectory, and as a result thereof, the accumulative movement distance which is actually measured is close to the actual accumulative movement distance. Furthermore, the same applies to a case where not only the steep curve but also a steep slope is generated in the path of the user, but is not illustrated in FIGS. 6A and 6B.

### 2. Modification Example

The disclosure is not limited to this embodiment, and is able to be modified within the range of the gist of the disclosure. Hereinafter, a modification example will be described. Furthermore, the same reference numerals are applied to the same elements as those of the embodiment, and the description thereof will be omitted.

### 2-1. Modification Example of Flow

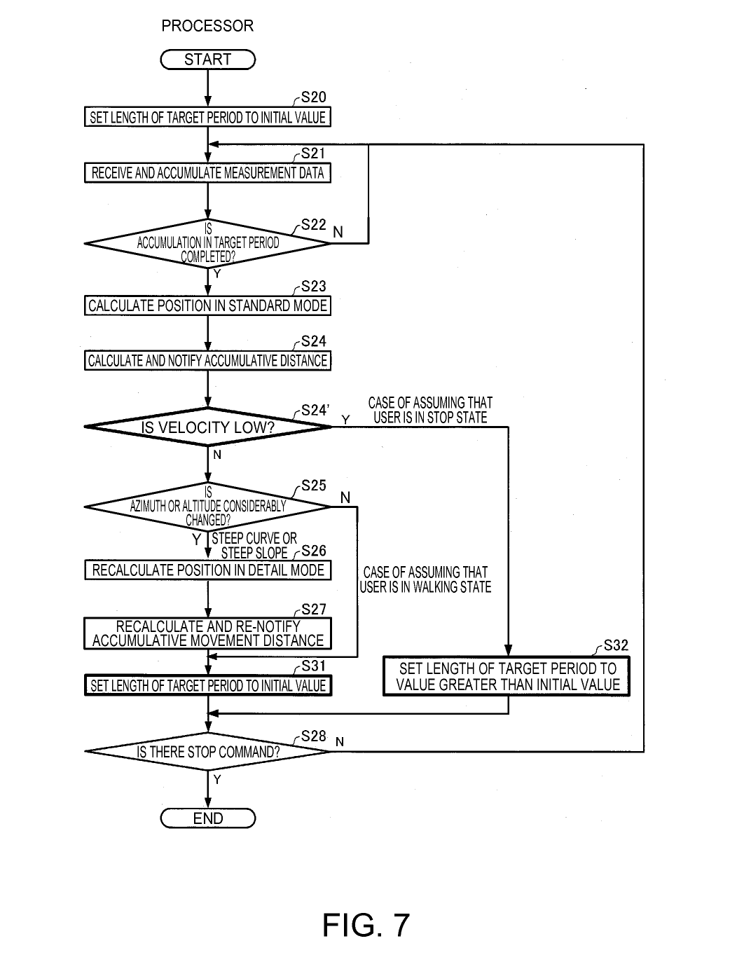

The processor 12 may execute a flowchart illustrated in FIG. 7 instead of the flowchart illustrated in FIG. 3B. The flowchart illustrated in FIG. 7 corresponds to a flowchart in which Steps S24′, S31, and S32 are added to the flowchart of FIG. 3B.

Furthermore, the flowchart of FIG. 7 visualizes the main procedure of the position calculation program 131, the operations of Steps S23 and S26 mainly correspond to the operation of the position calculator 121, and the operations of Steps S24′ and S25 mainly correspond to the operation of the determinator 122. Hereinafter, the flow of FIG. 7 will be described.

Steps S20 to S24: As with Steps S20 to S24 of the embodiment described above, the processor 12 performs the positioning calculation of the standard mode, the display of the temporary accumulative movement distance, and the like, and then the flow proceeds to Step S24′.

Step S24′: The processor 12, for example, recognizes the size of the movement velocity of the user on the basis of the temporary positioning data Vₜₑₘₚ which is acquired in Step S23, and when the size of the movement velocity is less than a predetermined threshold value, it is assumed that the user is in a stopped state, and thus the flow proceeds to Step S32, and when the size of the movement velocity is greater than or equal to the threshold value, it is assumed that the user is in a movement state, and thus the flow proceeds to Step S25. Furthermore, the threshold value of this step is a threshold value for determining whether or not the user is in the stopped state, and thus is able to be set to a sufficiently low value.

Steps S25 to S27: As with Steps S25 to S27 of the embodiment described above, the processor 12, as necessary, performs the positioning calculation of the detail mode, the display of the accumulative movement distance, and the like, and the flow proceeds to Step S31.

Step S31: The processor 12 sets the length of the target period to an initial value (T), and then the flow proceeds to Step S28. Accordingly, the length of the target period is maintained to the initial value (T) insofar as the user is not in the stopped state.

Step S32: The processor 12 sets the length of the target period to a value which is greater than the initial value (for example, 2T), and the flow proceeds to Step S28. Accordingly, in this embodiment, when it is determined that the user is in the stopped state, the length of the target period extends to a value greater than the initial value (T) (for example, 2T).

Step S28: The processor 12 determines whether or not the stop command is received, and when the stop command is not received, the flow returns to Step S21, and the processing relevant to the next target period starts. In contrast, when the stop command is received, the flow ends.

As described above, in the modification example, when it is determined that the user is in the stopped state, the length of the target period extends, and thus the sampling interval of the positioning data also extends. For this reason, the effect of low power consumption is high.

However, when the sampling interval extends, a chance of enabling the steep curve or the steep slope to be determined decreases.

However, in modification example, as with the embodiment described above, the positioning calculation of the detail mode which is shorter than the sampling interval is repeatedly performed in the same target period as that of the most recent standard mode at the timing at which the steep curve or the steep slope is generated.

For example, in the modification example, when the length of the target period of the most recent standard mode is T, the positioning calculation is performed by going back to the past by T, and when the length of the target period of the most recent standard mode is 2T, the positioning calculation is performed by going back to the past by 2T.

Accordingly, in the modification example, when the accumulation time of the measurement data is sufficiently ensured (that is, when the capacity of the measurement data table 133 is sufficiently ensured), the steep curve portion in the movement trajectory of the user or the sampling point for expressing the steep slope portion is able to be replenished after the steep curve or the steep slope is generated.

### 2-2. Another Modification Example of Flow

In the embodiment described above (also including the modification example), the following procedures (1) to (3) are sequentially and basically executed as notification processing of the accumulative movement distance in Steps S24 to S27 described above.

(1) The accumulative movement distance is calculated and notified.

(2) The presence or absence of a directional change is determined.

(3) When there is a directional change, the accumulative movement distance is recalculated and re-notified, and when there is no directional change, the recalculation and the re-notification are omitted.

Therefore, according to the procedures (1) to (3), the user is able to confirm both of the temporary accumulative movement distance and the defined accumulative movement distance. However, the temporary accumulative movement distance is deviated from a real accumulative orbit distance due to the influence of the steep curve or the like, and thus the user may become confused.

Therefore, in the embodiment described above (also including the modification example), the following procedures (1′) to (3′) may be sequentially executed instead of the procedures (1) to (3).

(1′) The accumulative movement distance is calculated.

(2′) The presence or absence of a directional change is determined.

(3′) When there is a directional change, the accumulative movement distance is recalculated and notified, and when there is no directional change, the accumulative movement distance calculated in (1′) is directly notified.

According to the procedures (1′) to (3′), the temporary accumulative movement distance is not notified, and thus it is possible to prevent the user from becoming unnecessarily confused.

In the embodiment described above (also including the modification example), at the time of determining the state of the user (Steps S24′ and S25), both of the steep curve determination and the steep slope determination are performed, and either the steep curve determination or the steep slope determination may be omitted.

In addition, in the embodiment described above, in the steep curve determination and the steep slope determination, the mode of the position calculation device 1 may be able to be switched between at least two modes among a mode in which the steep slope determination is omitted, a mode in which the steep curve determination is omitted, a mode in which both of the steep curve determination and the steep slope determination are omitted, and a mode in which both of the steep curve determination and the steep slope determination are not omitted.

For example, the mode in which the steep slope determination is omitted is suitable for running or the like on a flat area, the mode in which the steep curve determination is omitted is suitable for ski jumping or the like, and the mode in which both of the steep curve determination and the steep slope determination are not omitted is suitable for cross-country skiing, turn in skiing, trail running, climbing, and the like.

In addition, in the embodiment described above, the GPS unit 10 is used for determining the state of the user (Steps S25 and S24′), a sensor having a different principle from that of the GPS unit 10 may be used or used together in order to determine the state (Steps S25 and S24′). As the sensor which is able to be used or used together, a sensor which is able to detect the posture or the like of the user, for example, a geomagnetic sensor, a gyro sensor, an atmospheric pressure sensor, an acceleration sensor, and the like are included.

For example, the atmospheric pressure sensor is suitable for particularly sensing a component of an altitude direction among the movement velocity or the acceleration of the user.

In addition, for example, when a triaxial direction acceleration sensor is used, a body vibration frequency of the user may be detected by the triaxial direction acceleration sensor, a relational expression between the output of the acceleration sensor and the movement velocity of the user may be learned in advance, the output of the acceleration sensor may be applied to the learnt relational expression while the user is moved, and the movement velocity of the user may be assumed.

In addition, in the embodiment described above, the GPS unit 10 is used for determining the state (Steps S25 and S24′), and thus the cycle for repeating the state determination is identical to the length of the target period, but when the GPS unit 10 is not used for determining the state (Steps S25 and S24′), the cycle for repeating the state determination is able to be independently set from the length of the target period. For example, the cycle for repeating the state determination is able to be fixed while the length of the target period expands and contracts.

In addition, in the embodiment described above, the processing relevant to the standard mode is continuously performed (Steps S23 and S24) regardless of the result of the determination processing of the steep curve or the steep slope (Step S25), but when the number of times of continuous detection of the steep curve or the steep slope is greater than a threshold value, the determination and the processing of the standard mode (Steps S25, S23, and S24) may be skipped M times (here, M is an integer of greater than or equal to 1). Alternatively, when the number of times of the continuous detection is greater than the threshold value, the determination and the processing of the standard mode (Steps S25, S23, and S24) may be paused.

Accordingly, for example, under a usage situation in which the steep curve or the steep slope is frequently generated such as skiing, unnecessary processing is omitted, and thus electric power saving is able to be realized.

In addition, in the embodiment described above, the determination processing of the steep curve or the steep slope (Step S25) is continuously performed, but when the number of times of continuous non-detection of the steep curve or the steep slope is greater than a threshold value, the determination and the processing of the detail mode (Steps S25, S26, and S27) may be skipped over M′ times (here, M′ is an integer of greater than or equal to 1). Alternatively, when the number of times of the continuous non-detection is greater than the threshold value, the determination and the processing of the detail mode (Steps S25, S26, and S27) may be paused.

Accordingly, for example, under a usage situation in which the steep curve or the steep slope is frequently generated such as walking, unnecessary processing is omitted, and thus electric power saving is able to be realized.

In addition, in the embodiment described above, the consumed power of the positioning calculation of the detail mode (Step S26) is greater than the consumed power of the positioning calculation of the standard mode (Step S23), and thus the presence or absence of the processing relevant to the detail mode (Steps S26 and S27) may be determined according to the remaining battery level of the position calculation device 1. For example, when the remaining battery level of the position calculation device 1 is less than a threshold value, the flow of the processor 12 may be changed such that the processing relevant to the detail mode (Steps S26 and S27) is not performed.

In addition, in the embodiment described above, the presence or absence of the processing relevant to the detail mode (Steps S26 and S27) may be determined according to a usage mode or the like of the position calculation device 1. For example, the flow of the processor 12 may be changed such that the processing relevant to the detail mode (Steps S26 and S27) is performed when the position calculation device 1 is used in a skiing mode in which the steep curve or the steep slope is frequently generated, and the processing relevant to the detail mode (Steps S26 and S27) is not performed when the position calculation device 1 is used in a walking mode in which the steep curve or the steep slope is not frequently generated. Furthermore, in this case, the user may designate the usage mode of the position calculation device 1 before using the position calculation device 1.

In addition, in the embodiment described above, the values of the sampling cycle of the measurement data, the sampling cycle of the standard mode (the length of the target period), the sampling interval of the detail mode (the length of the short period), and the like are able to be arbitrarily changed. However, all of the sampling cycle of the standard mode (the length of the target period) and the sampling interval of the detail mode (the length of the short period) have to be set to be equal to the integer multiple of the sampling cycle of the measurement data.

In addition, in the embodiment described above, the sampling interval of the detail mode (the length of the short period) is fixed, but may be changed according to the degree of the steep curve or the steep slope. For example, the sampling interval of the detail mode (the length of the short period) may be shortened as the degree of the steep curve or the steep slope becomes larger (as the amount of directional change becomes larger).

In addition, in the embodiment described above, the accumulative movement distance is displayed on the display 15 in real time during the sampling of the measurement data (Steps S24 and S27), and the accumulative movement distance may be displayed on the display 15 during the sampling of the measurement data or when the user requires the display after the sampling stops.

### 2-3. Another Modification Example

In the embodiment described above, a part or all of the functions of the processor 12 may be included in the GPS unit 10 side. In addition, a part of the functions of the GPS unit 10 may be included on the processor 12 side.

In addition, in the embodiment described above, a part or all of the processing of the processor 12 may be executed by the external device of the position calculation device 1 (a tablet PC, a laptop PC, a desktop PC, a smart phone, a network server, and the like).

In addition, in the embodiment described above, the position calculation device 1 may transmit (upload) a part or all of the acquired data to the external device such as a network server. The user may browse or download the uploaded data, as necessary, by using the position calculation device 1 or the external device (a personal computer, a smart phone, and the like).

In the embodiment described above, the positioning data acquired by the positioning calculation of the detail mode and the positioning data acquired by the positioning calculation of the standard mode may be separated on the display 15 of the position calculation device 1 or on a display of the external device. For example, the positioning data acquired by the positioning calculation of the detail mode and the positioning data acquired by the positioning calculation of the standard mode may be displayed in colors different from each other.

In addition, in the embodiment described above, when the position calculation device 1 or the external device displays the movement trajectory of the user on the terminal, smoothing processing may be performed with respect to the movement trajectory, and thinning out processing may be performed with respect to the sampling point.

In addition, at this time, the parameters of the processing may be different between a portion in which the steep curve or the steep slope is generated (a portion in which the sampling points of the detail mode are arranged) and a portion in which the steep curve or the steep slope is not generated (a portion in which the sampling points of the standard mode are arranged).

For example, the smoothing processing may be performed with respect to the portion in which the steep curve or the steep slope is generated, and the smoothing processing may not be performed with respect to the portion in which the steep curve or the steep slope is not generated.

Alternatively, the thinning out processing of the sampling point may not be performed with respect to the portion in which the steep curve or the steep slope is generated, and the thinning out processing of the sampling point may be performed with respect to the portion in which the steep curve or the steep slope is not generated.

In addition, when the position calculation device 1 or the other device displays the movement trajectory of the user on a map in an overlapping manner, the sampling point is generally thinned as a display region of the map becomes wider, but when this embodiment is applied, a thinning out amount in the portion in which the steep curve or the steep slope is generated may be less than a thinning out amount in another portion.

In addition, the position calculation device 1 may be a portable information device such as a head mount display (HMD), and a smart phone.

In addition, in the embodiment described above, a mounting destination of the position calculation device 1 is the wrist or the like of the user, and may be other portions such as the waist of the user. For example, the mounting destination of the position calculation device 1 is the body trunk of the user (a portion excluding four extremities). However, the mounting destination of the position calculation device 1 is not limited to the body trunk, and may be, for example, the head or the leg of the user other than the arm.

In addition, in the embodiment described above, the position calculation device 1 is configured as a single device, and may be configured by a system including a plurality of devices. In this case, a device having a function of detecting at least the position or the posture of the user (the GPS unit or the sensor) is mounted on the body of the user.

In addition, in the embodiment described above, the notification with respect to the user is performed by an image or a sound (the display 15 or the sound output unit 16), and may be performed by a vibration pattern or the like.

In the embodiment described above, running or the like is described as sporting activity using the position calculation device 1, and the sporting activity may be sporting activities other than running or exercise. For example, the position calculation device 1 is also able to be applied to walking, climbing, skiing (also including cross-country skiing or ski jumping), swimming, skating, golf, tennis, baseball, soccer, motor cycle, motor sporting activity, boating (a motorboat race), yachting, trail running, paragliding, kite-flying, dog sleighing, a flying robot (radio control), rehabilitation, and the like.

In the embodiment described above, the mounting destination of the position calculation device 1 is a person, and a movable body other than the person, for example, the other movable body such as an animal, a walking robot, a bicycle, and an automobile which has a directional change at a certain velocity or higher.

In addition, in the embodiment described above, a global navigation satellite system (GPS) is used as a global satellite measurement system, and other global navigation satellite systems (GNSS) may be used. For example, one or two or more of satellite measurement systems of a European geostationary-satellite navigation overlay service (EGNOS), a quasi zenith satellite system (QZSS), a global navigation satellite system (GLONASS), GALILEO, a BeiDou navigation satellite system (BeiDou), and the like may be used. In addition, a stationary satellite type satellite-based augmentation system (SBAS) such as a wide area augmentation system (WAAS), and a European geostationary-satellite navigation overlay service (EGNOS) may be used in at least one of the satellite measurement systems.

In addition, each of the embodiments and each of the modification examples described above are an example, and the disclosure is not limited thereto. For example, each of the embodiments and each of the modification examples are able to be suitably combined.

In addition, the disclosure includes a configuration which is substantially identical to the configuration described in the embodiment (for example, a configuration having the same function, method, and result as those of the configuration described in the embodiment, or a configuration having the same object and effect as those of the configuration described in the embodiment). In addition, the disclosure includes a configuration in which parts which are not essential to the configuration described in the embodiment are substituted. In addition, the disclosure includes a configuration which is able to attain the same functional effect as that of the configuration described in the embodiment or a configuration which is able to attain the same object as that the configuration described in the embodiment. In addition, the disclosure includes a configuration in which a known technology is added to the configuration described in the embodiment.

What is claimed is:

1. A position calculation method, comprising:
calculating a position of a movable body for a predetermined time period;
determining whether or not there is a directional change of the movable body; and
if it is determined that there is a directional change, recalculating a position of the movable body for each short period in a period which begins earlier than the time at which the determining is performed, wherein the short period is shorter than the predetermined time period.

2. The position calculation method according to claim 1,
wherein if an amount of directional change per unit time of the movable body is greater than a predetermined value, it is determined that there is a directional change.

3. The position calculation method according to claim 1, further comprising:
acquiring and storing data used for the calculating the position for each time period which is less than or equal to a length of the short period.

4. The position calculation method according to claim 3,
wherein if it is determined that there is a directional change, the position is calculated using the data in the short period.

5. The position calculation method according to claim 1,
wherein the calculating is performed for two or more of the predetermined time periods, and
wherein the determining is performed for each of the predetermined time period.

6. The position calculation method according to claim 1, further comprising:
determining whether or not the movable body stops; and
extending the length of the predetermined time period if it is determined that the movable body stops.

7. The position calculation method according to claim 1,
wherein signals from a plurality of positioning satellites is used for calculating the position.

8. A position calculation device, comprising:
a position calculator calculating a position of a movable body for a predetermined time period; and
a determinator determining whether or not there is a directional change of the movable body,
wherein if it is determined that there is a directional change, the position calculator recalculates a position of the movable body for each short period in a period which begins earlier than the time at which the determining is performed, wherein the short period is shorter than the predetermined time period.

9. A position calculation program stored in a non-transitory computer readable medium causing a computer to execute:
calculating a position of a movable body for a predetermined time period;
determining whether or not there is a directional change of the movable body; and
if it is determined that there is a directional change, recalculating a position of the movable body for each short period in a period which begins earlier than the time at which the determining is performed, wherein the short period is shorter than the predetermined time period.
